(19) United States
(12) Patent Application Publication
(10) Pub. No.: US 2014/0103587 A1
(43) Pub. Date: Apr. 17, 2014

(54) Structure of Cushion Pad

(71) Applicant: Universal Trim Supply Co., Ltd., New Taipei City (TW)

(72) Inventor: Shih-Sheng Yang, New Taipei City (TW)

(73) Assignee: Universal Trim Supply Co., Ltd., New Taipei City (TW)

(21) Appl. No.: 14/140,542

(22) Filed: Dec. 26, 2013

Related U.S. Application Data
(63) Continuation-in-part of application No. 12/701,591, filed on Feb. 7, 2010.

(30) Foreign Application Priority Data
Nov. 28, 2013 (TW) 102222291

(51) Int. Cl. F16F 13/08

(52) U.S. Cl. CPC F16F 13/08
USPC 267/140.13

(57) ABSTRACT

A structure of a cushion pad includes a main body and a plat. The main body is made of an elastic material and has a surface on which at least one raised pad unit having a hollowed interior is formed. The pad unit has a top wall forming a plurality of hollow column bladders that is inwardly recessed into the hollowed interior. Bottoms of the column bladders and a bottom circumference of the pad unit are bonded to the plate so as to form an enclosed pad. As such, the pad can be applied and mounted to various products that require cushioning. The hollow column bladders of the pad are compressible to induce elastic cushioning that provides an effect of comfortableness thereby providing functions of shock damping and protection.

### CROSS-REFERENCE TO RELATED APPLICATION

This is a continuation-in-part of co-pending U.S. patent application Ser. No. 12/701,591 filed on Feb. 7, 2010 and owned by the present applicant.

### TECHNICAL FIELD OF THE INVENTION

The present invention generally relates to a structure of a cushion pad that provides functions of shock damping and protection and is applicable to a cushioning material for loading or shock absorption for various products, such as a liner pad of a shoe sole, a shoulder pad of a backpack, or an inner lining of a motorcyclist's helmet.

### DESCRIPTION OF THE PRIOR ART

Various consumers' products that are generally worn by a person, such as a bicyclist's helmet, a backpack that is carried on the back of a person, and a shoe that is put on a foot of a person, are generally designed in consideration of the outside appearances and the functionalities thereof. Taking the bicyclist's helmet as an example, the structure of the helmet generally comprises a shell made of a rigid foamed material in which a liner made of a soft material is mounted. The helmet is generally subject to severe inspection according various regulations so that once put on the head of a wearer, the helmet can protect the head from damage caused by external impacts. Most of the bicyclist's helmets that are available in the market are mass-produced products and they are generally not precisely fit to the head contours of different wearers. Consequently, a wearer who wears the helmet may not have comfortableness and sufficient enclosure of the head so that the shocking force acting on the head cannot be well controlled during the events of head impacts. Further, the same problems concerning comfortableness, cushioning, and protection can also be found in other products, such as backpack and shoes. Thus, it is desired to provide a device that is applicable to such products to overcome such problems.

Further, U.S. patent application Ser. No. 12/701,591, which is own by the present applicant, discloses an “air cushion pad”, which shows in FIGS. 21-22 thereof, an air cushion pad that is composed of an upper sheet member and a lower sheet member. The upper sheet member is integrally made in a configuration having a curved surface in such a way that tubes extend downwardly in a vertical direction from the curved surface that is inwardly concave; and the lower sheet member is integrally made in a configuration having a curved surface in such a way that tubes extend upwardly in a vertical direction 14 from the curved surface that is outwardly convex. When the tubes are inter-fit to each other with circumferential edges of the inwardly concave curved surface and the outwardly-convex curved surface flat engaging each other to allow for application of a high-frequency machining or ultrasonic plastic fusion operation, a hot pressing bonding operation, or adhesives thereto to form an air sack like cushion pad. Due to the inter-fit engagement between tubes of the upper and lower sides, the air sack like cushion pad so made exhibits a relatively stiff elasticity of the entire cushion pad. This is because the deformability of the cushion pad is constrained by limited horizontal displacement of the tubes. Consequently, such a structure is not fit for a liner that serves as a lining material of a bicycle's helmet. And, it is necessary to provide a different structural design for a lining material for a shoe pad, a shoulder pad of a backpack, and a liner of a bicyclist's helmet.

Thus, the present invention aims to provide a structure of a cushion pad that has a simple structure and is practical for the general consumers.

### SUMMARY OF THE INVENTION

The primary object of the present invention is to provide a structure of a cushion pad that has a simple overall structure, is easy to manufacture, and provides functions of dampening shocks and alleviating impact forces.

To achieve the above object, the present invention provides a structure of a cushion pad, which generally comprises a main body and a plate bonded to a bottom of the main body. The main body is made of an elastic material and has a surface on which at least one raised pad unit having a hollowed interior is formed. The pad unit has a top wall forming a plurality of hollow column bladders that is inwardly recessed into the hollowed interior. Bottoms of the column bladders and a bottom circumference of the pad unit are bonded, through ultrasonic processing, to the plate so as to form an enclosed pad. As such, the pad can be applied and mounted to various products that require cushioning, such as a shoe sole, a backpack, and a helmet. The hollow column bladders of the pad are compressible to induce elastic cushioning that provides an effect of comfortableness so as to alleviate impacts thereby providing functions of shock damping and protection.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a first embodiment of the present invention.

FIG. 2 is a perspective view, partly broken, showing the first embodiment of the present invention in an assembled form.

FIG. 3 is a schematic view showing a cushioning effect achieved with compression of a hollow column bladder of a cushion pad according to the present invention.

FIG. 4 is a schematic view illustrating an application of the first embodiment the present invention to a shoe sole.

FIG. 5 is a perspective view showing a second embodiment of the present invention in an assembled form.

FIG. 5A is an enlarged view of a circled portion of FIG. 5 designated at A.

FIG. 6 is a schematic view illustrating an application of the second embodiment of the present invention to a backpack.

FIG. 7 is a schematic view illustrating an application of the second embodiment of the present invention to a helmet.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

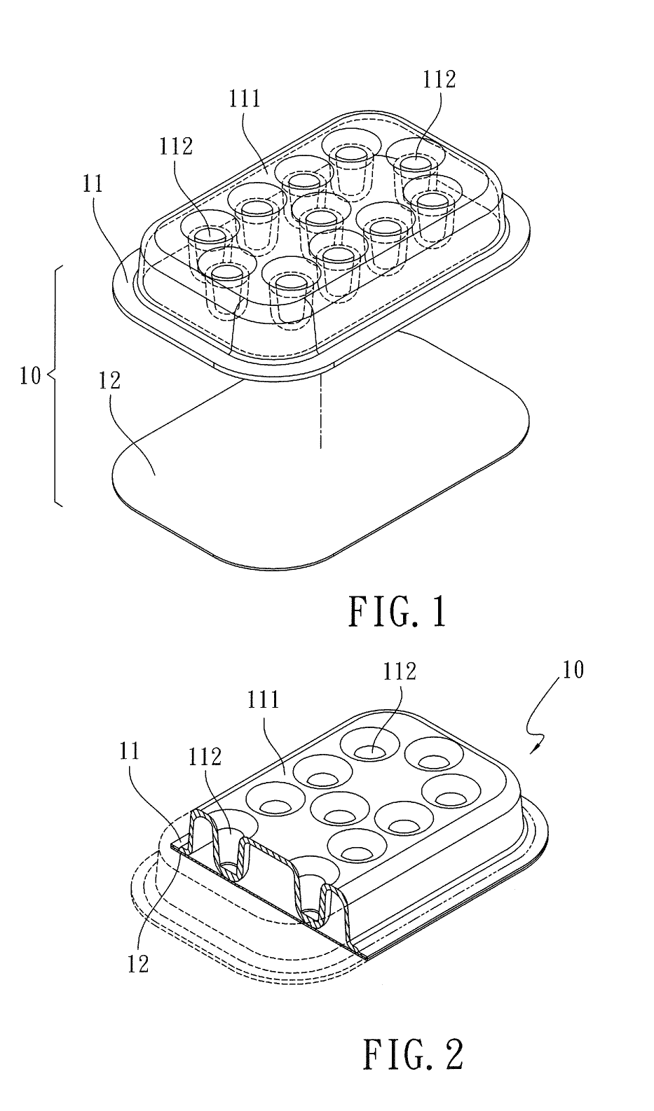

Referring to FIGS. 1-3, the present invention provides a cushion pad 10, which comprises, structurally, a main body 11 and a plate 12. The main body 11 is made of a soft and elastic plastic material and has a surface on which at least one raised pad unit 111 that has a hollowed interior is formed (wherein in the instant embodiment, an arrangement of only a single pad unit is provided). The pad unit 111 has a top wall that forms a plurality of hollow column bladders 112 that is inwardly recessed into the hollowed interior of the pad unit. The plate 12 has an outer contour that corresponds in shape to a bottom of the main body 11 and the plate 12 is also made of an elastic plastic material.

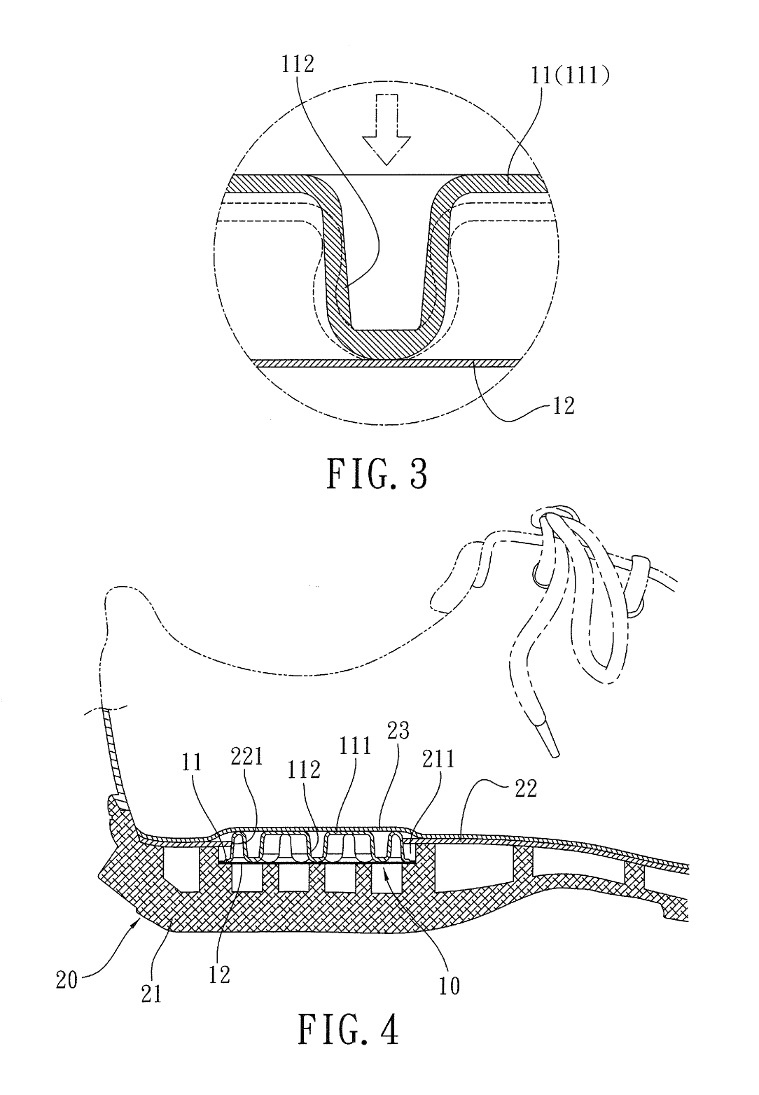

In the manufacture, the main body 11 and the plate 12 are set in alignment with each other and an ultrasonic processing operation is applied to securely bond a bottom circumference of the pad unit 111 of the main body 11 and bottoms of the hollow column bladders 112 to the plate 12 through fusion so as to form the cushion pad 10 that is in an enclosed form and exhibits internal support. As such, when the cushion pad 10 is subjected to compression by an external force, bending and deformation of the hollow column bladders 112 located and supporting inside the cushion pad 10 can provide an effect of shock damping (as shown in FIG. 3).

Referring to FIG. 4, an example is given to illustrate an application of the present invention to a shoe sole 20. Generally, a shoe sole 20 has a structure that is composed of an outsole 21, a midsole 22, and an insole 23. In the example, the outsole 21 has a heel portion having a bearing surface in which a cavity 211 is formed for accommodating the cushion pad 10 according to the present invention. The midsole 22 has a board like body in which an opening 221 is formed at a location corresponding to the cavity. The midsole 22 has an outer contour that corresponds to an inside circumferential surface of the outsole 21, wherein in the manufacture, the midsole 22 is adhered to the outsole 21 in such a way that the pad unit 111 of the cushion pad 10 is allowed to extend partially out of the opening 221 and then, the insole 23 is directly positioned on the midsole 22. Thus, when a foot wearing the shoe is stepping down, the heel of the foot can be supported by the pad unit 111 of the cushion pad 10 to compress the inside-located hollow column bladders 112 that induce a comfortable support through cushioning achieved with the flexibility of the material so as to provide the functions of shock damping and protection. Similarly, the cushion pad 10 can be applied to a different portion of the shoe sole 20 that corresponds to the foot sole so that both the heel and foot sole are provided with a comfortable cushioning effect.

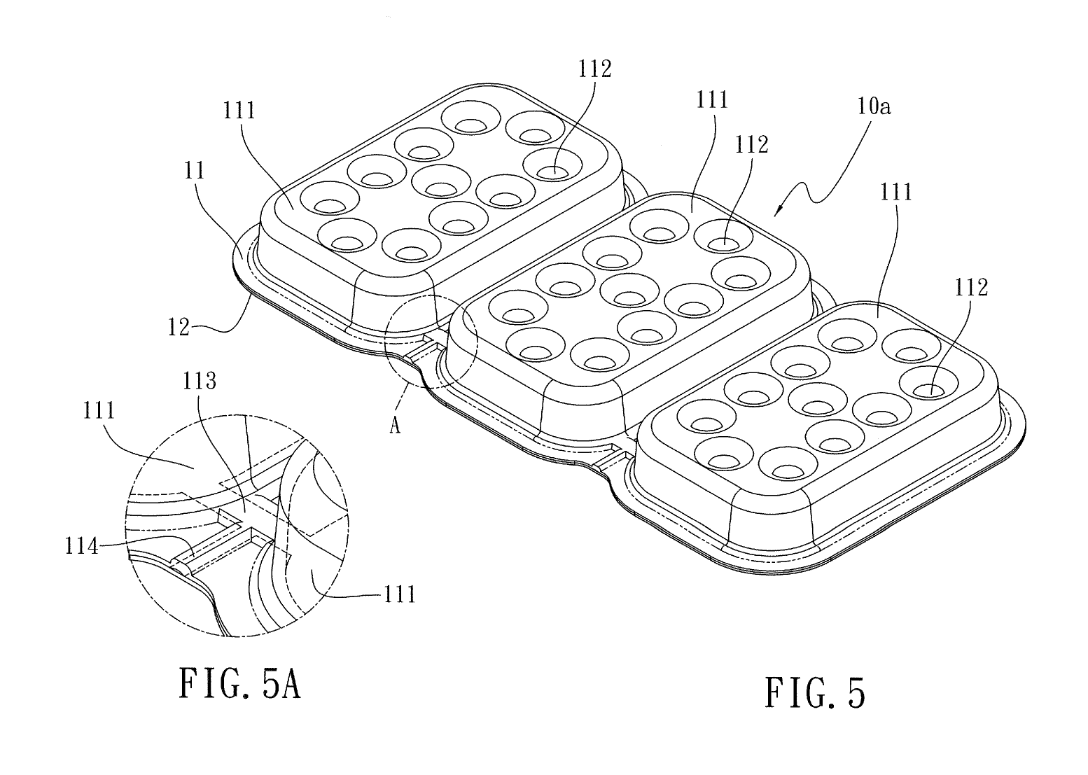

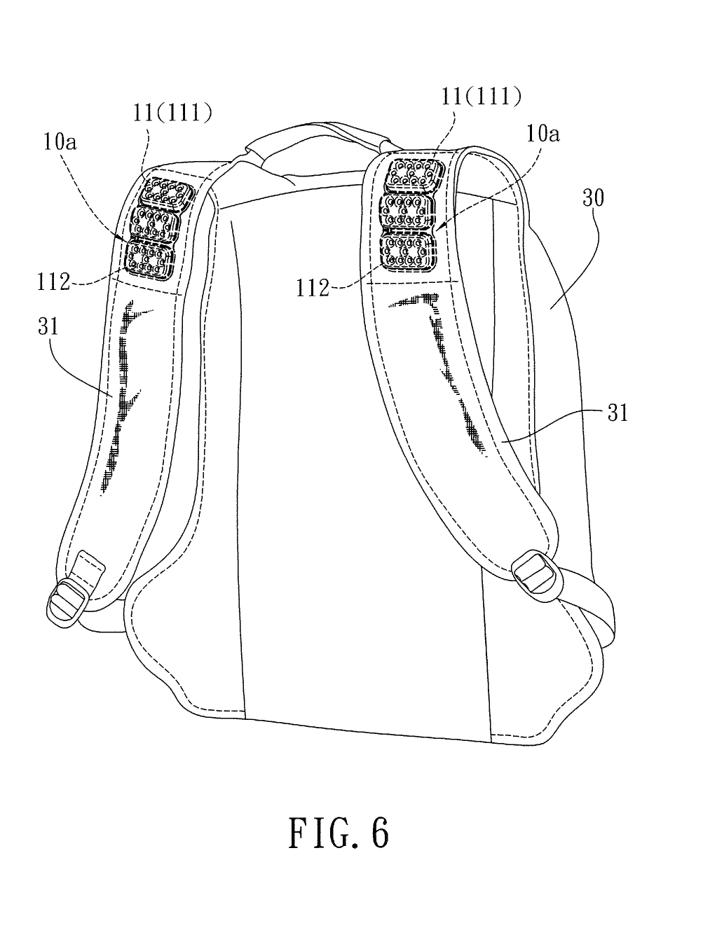

Referring to FIGS. 5-7, a different arrangement of the present invention and examples of application thereof are shown. As shown in FIG. 5, a cushion pad 10a of the present invention can alternatively be provided with a plurality of raised pad units 111 that each have a hollowed interior and are formed on a surface of a main body 11. The pad units 111 have bottom circumferences that are bonded, through ultrasonic processing, to a plate 12, communication passages 113 are formed and connected between the pad units 111. As such, the cushion pad 10a is applicable to a shoulder strap 31 of a backpack 30 to serve as a shoulder pad (as shown in FIG. 6), whereby the shoulder strap 31 can provide a cushioning effect. Further, when the backpack 30 is born on the back of a user, the pad units 111 may be subjected to different loadings and the cushion pad 10a allows internal air of the pad units 111 that are subjected to a greater loading to flow through the communication passages 113 to the other pad units 111 that surround the pad units of greater loading so that the surrounding pad units 111 are increased for the internal pressures thereof, whereby the overall cushioning effect of the cushion pad can be properly adjusted to make the user more comfortable in carrying the backpack.

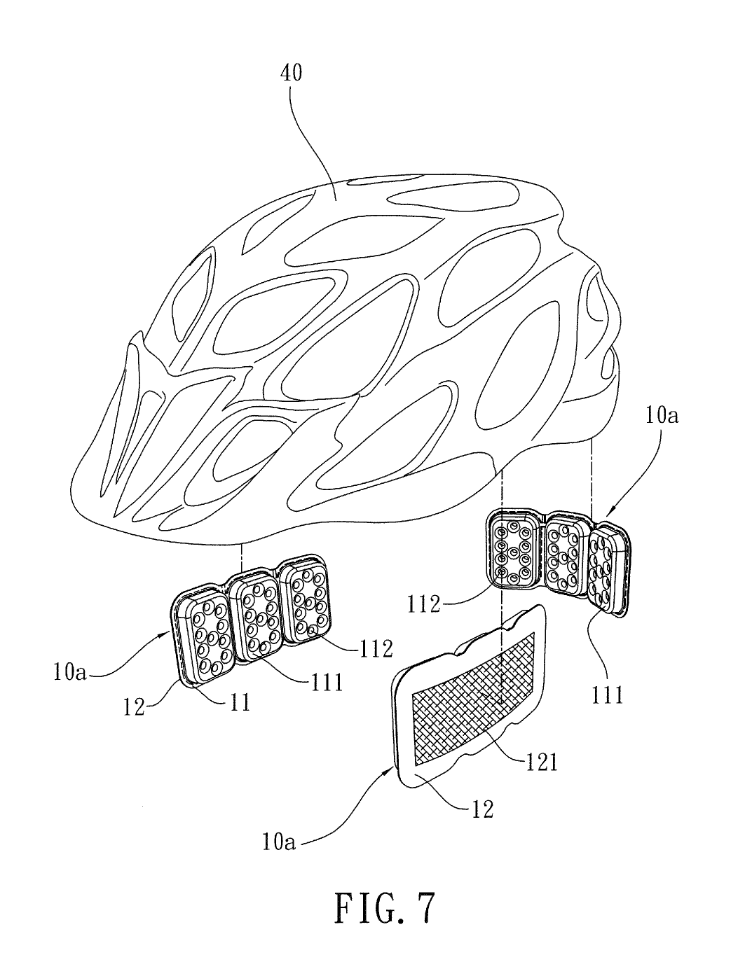

In a further embodiment of the present invention, during the application of the ultrasonic processing for bonding, the cushion pad 10a may additionally provided with a ventilation channel 114 (as shown in FIG. 5A) extending from for example one or more of the communication passages 113 and communicating with the surrounding atmosphere. In addition, a bottom of the plate 12 is provided with a part of a hook and loop fastener 121 to allow the user to attach the cushion pad to another part of the fastener or a fabric having similar property. As shown in FIG. 7, an application of the present invention to a helmet 40 as a liner is illustrated. When the helmet is put on the head of a wearer, the cushion pad 10a can automatically adjust according to the contour of the head to allow the head to be enclosed in a tight and completely engaging manner so as to provide a complete effect of cushioning, which ensures more effectively bearing and absorption of external forces when the helmet is subjected to impact thereby achieving an excellent cushioning and protection effect of the head. Further, the arrangement of the ventilation channel 114 allows excessive air to be discharged out when the pad units 111 are subjected to compression and pressing so that the wearer will not feel over-tightness and optimum comfortableness can be achieved

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cushion pad, which comprises a main body and a plate and is characterized in that:
the main body is made of a soft elastic material and has a surface on which at least one raised pad unit having a hollowed interior is formed, the pad unit having a top wall forming a plurality of hollow column bladders that is inwardly recessed into the hollowed interior, bottoms of the hollow column bladders and a bottom circumference of the pad unit being bonded to the plate to form an enclosed pad, whereby the hollow column bladders are compressible to induce elastic cushioning that is adapted to provide an effect of comfortableness so that the pad provides functions of shock damping and protection.

2. The cushion pad according to claim 1, wherein the bottom circumference of the pad unit that is bonded to the plate is provided with a communication passage for establishing fluid communication with another pad unit mounted to the plate.

3. The cushion pad according to claim 2, wherein the communication passage is provided with a ventilation channel extending therefrom and adapted to communicate with the surrounding atmosphere.
